(19) United States
(12) Patent Application Publication
(10) Pub. No.: US 2022/0363389 A1
(43) Pub. Date: Nov. 17, 2022

(54) CARGO CONVEYING SYSTEM, AIRCRAFT AND METHOD OF PROVIDING A WIRED CARGO CONVEYING SYSTEM

(71) Applicant: TELAIR INTERNATIONAL GMBH, Miesbach (DE)

(72) Inventor: Matthias URCH, Egmating (DE)

(21) Appl. No.: 17/740,671

(22) Filed: May 10, 2022

(30) Foreign Application Priority Data
May 14, 2021 (DE) 102021112558.8

(51) Int. Cl. B64D 9/00; B64C 1/22; B64C 1/06

(52) U.S. Cl. CPC B64D 9/00; B64C 1/22; B64C 1/061; B64D 2009/006

(57) ABSTRACT

A cargo conveying system for conveying cargo items, in particular containers and/or pallets, in a cargo hold of an aircraft having at least one cargo conveying device, in particular roller conveyors. The cargo conveying device includes at least one frame, at least one roller drive unit having at least one roller for conveying the cargo items, at least one main line strand, in particular a partial cable harness, arranged on the frame, and at least one distributor module for connecting the at least one main line strand to at least one further main line strand. The distributor module is arranged on the frame and is connected to the roller drive unit via at least one secondary line strand.

### CROSS REFERENCE TO RELATED APPLICATIONS

This application claims priority to German Patent Application No. 102021112558.8, filed May 14, 2021. The disclosure set forth in the referenced application is incorporated herein by reference in its entirety.

### FIELD OF THE DISCLOSURE

The invention relates to a cargo conveying system, an aircraft having such a cargo conveying system, and a method of providing a wired cargo conveying system.

### BACKGROUND

In general, aircraft cargo decks can be equipped with cargo conveying devices (PDUs: Power Drive Units) to facilitate the loading and unloading of cargo on the cargo deck. The cargo conveying devices provide the necessary force to transport the cargo. A control computer controls these cargo conveying devices to preferably enable substantially automatic loading and unloading.

In order to operate the cargo conveying devices, it is known that the said devices are connected to at least one wiring harness that is routed under the cargo hold floor in the aircraft structure. In the prior art, such a wiring harness runs along the entire cargo hold length of the aircraft. Such underfloor wiring results in increased planning and certification efforts, as separation guidelines from other aircraft wiring harnesses, critical systems (e.g., hydraulic or fuel lines), and obstructions must be met. In addition, in the aircraft fueling area, the wiring harness must be protected against damage. Aviation authorities require complex analyses in these critical areas to prove safety. In accordance with the present regulations and guidelines, the wiring harness or cabling must generally be fastened to the aircraft structure with holders provided for this purpose.

In order to operate the cargo conveying devices, a branch is provided in the cable harness at each position of the cargo conveying devices, which terminates at a plug-in device underneath the cargo hold floor. An adapter cable is conventionally connected to this plug-in device, which is routed through the cargo hold floor to the cargo conveying device. The disadvantage here is that the adapter cable runs through a feedthrough provided in the cargo hold floor. In general, feedthroughs in the cargo hold floor should be avoided, as they represent weak points with regard to the tightness of the cargo hold. The feedthroughs must therefore be sealed at great expense in order to prevent the escape of extinguishing agent from the cargo hold in the event of a fire. Frequently, the adapter cabling is equipped with a rubber eyelet that is seated in the feedthrough. On cargo decks with a large number of cargo conveying devices and thus a large number of feedthroughs, the sealing effort is therefore very high.

A further disadvantage is that the branch to the plug-in device and the adapter cable routed through the cargo hold floor result in an increased cable length. Such designs result in increased weight and increased material and assembly costs.

Another disadvantage of the prior art is that after installation, the cable harness must be checked for correct assembly, especially with regard to pin assignment, and for damage. This is very time-consuming due to the difficult accessibility.

### SUMMARY

The invention is therefore based on the object of providing a cargo conveying system in which the planning and certification effort and the assembly effort are reduced and accessibility, in particular in the case of maintenance, is improved. Furthermore, it is the object of the invention to disclose an aircraft and a method for providing a wired cargo conveying system.

This object is solved with respect to the cargo conveying system, the aircraft and the method in accordance with the present disclosure.

In particular, the object is solved by a cargo conveying system for conveying pieces of cargo, in particular containers and/or pallets, in a cargo hold of an aircraft, having at least one cargo conveying device, in particular roller conveyors, wherein the cargo conveying device comprises the following:
at least one frame;
at least one roller drive unit having at least one roller for conveying the cargo items;
at least one main wiring harness, in particular a partial wiring harness, arranged on the frame; and
at least one distributor module for connecting the at least one main line strand to at least one further main line strand, wherein the distributor module is arranged on and/or in the frame and is connected to the roller drive unit via at least one secondary line strand.

One idea of the present invention is to arrange the distributor module on the frame, or at least above the cargo deck. The frame may serve as a support for the distributor module and/or for the roller drive unit. Preferably, the cargo conveying device has a plurality of roller drive units each connected to a distributor module. Alternatively, the distributor module may be connected to a plurality of roller drive units.

The invention has the advantage that the distributor module is quickly and easily accessible from the cargo hold as a branching point for power supply and/or communicative connection of the roller drive unit as well as for connection of two main line strands, in particular two partial cable harnesses. There is thus no need for time-consuming dismantling of any floor elements of the cargo hold in order to access line strands or cable harnesses and/or plug-in devices and/or terminal blocks below the cargo hold floor. Maintenance is therefore greatly facilitated. Furthermore, the distributor module enables simple and fast connection of several partial cable harnesses to form a continuous network or bus.

The roller drive unit is preferably arranged on the frame. The roller drive unit is preferably arranged on the frame in such a way that the at least one roller can be brought into contact or is in contact with at least one cargo item during operation, in particular when the roller drive unit is actuated. Preferably, the cargo conveying device is a roller conveyor in which the at least one roller drive unit and the associated distributor module are arranged.

The frame preferably extends in a longitudinal direction. The frame can be U-shaped, e.g. as a U-section. Preferably, the frame has two side walls between which the distributor module and the roller drive unit are arranged. The roller drive unit and the distributor module are preferably arranged adjacent to each other in the longitudinal direction. Here it is advantageous that the distributor module and the roller drive unit are arranged to save space, so that installation space is saved.

According to the invention, the distributor module is connected to two main line strands and a secondary line strand connected to the roller drive unit. Preferably, at least one incoming and one outgoing partial wiring harness are connected to the distributor module. Further preferably, the main line strands are connected to each other electrically and/or communicatively, in particular in a signal-transmitting manner, by the distributor module. The distributor module has the task of connecting the roller drive unit to at least one of the main line strands via the secondary line strand. The secondary line strand is preferably a connecting cable that forms a spur line between the distributor module and the roller drive unit. Preferably, the distributor module and the roller drive unit are arranged substantially on a common plane on the frame. The distributor module can assume the function of connecting or joining at least two main line strands, in particular partial cable harnesses, and/or branching off lines for controlling and/or supplying the roller drive units.

At least one of the main line strands may be arranged on the frame. Thus, in one embodiment, the invention allows the main line strands to run on the frame rather than underneath the cargo hold floor, as is known from the prior art. The advantage of this is that there is no need for an elaborately sealed line feedthrough in the cargo hold floor, and planning and certification measures are reduced. Furthermore, it is advantageous that corrosion protection of grounding lines as well as an addressing line for the roller drive unit, which are conventionally connected to the aircraft structure below the cargo hold floor, can be omitted. Preferably, the main line strands are arranged to extend along the frame.

Furthermore, the main line strand and in particular the further main line strand can be preassembled on the frame before installation. This makes assembly much easier and thus saves costs. It is possible for the cargo conveying device, in particular the roller conveyor, to be composed of several frame pieces, e.g. U-sections, arranged one after the other. Several roller drive units and several distributor modules can be provided on at least one frame piece. In each case, a roller drive unit can be connected to one of the distributor modules. Alternatively or additionally, a plurality of roller drive units and at least one distributor module can be arranged on at least one frame piece, with the distributor module being connected to a plurality of, in particular at least two, roller drive units.

In one embodiment, a roller drive unit and a distributor module connected to the roller drive unit may be arranged on at least one frame piece. In a (further) embodiment, at least three roller units and at least three distributor modules can be arranged on at least one frame piece, wherein each of the roller drive units are connected to one of the distributor modules. In a further embodiment, at least three roller units and a distributor module connected to the roller units may be arranged on at least one frame piece.

The respective main line strands preferably have electrical lines for the voltage supply, in particular for the AC voltage and DC voltage supply, of the roller drive unit as well as at least one grounding line. An AC voltage of 115 volts with a frequency of 400 hertz and/or a DC voltage of 28 volts can be provided for operating the roller drive unit. In addition, the main line strands have at least one line for signal transmission, in particular for data transmission. For this purpose, a data bus system may be provided, which is preferably a CAN-BUS system. Likewise, the secondary line strand may comprise the aforementioned lines.

In a preferred embodiment, the distributor module has a (waterproof) housing and at least one distribution element integrated in the housing, in particular a printed circuit board, having a plurality of connection points to which the main line strands and/or the secondary line strand are connected. In other words, the connection points for the main line strands and/or the secondary line strand are located within the housing on the distribution element. The housing is preferably waterproof, i.e. sealed against moisture. Here, it is advantageous that a sealing effort is reduced, since the connection points are located in the housing and thus only the strand feedthrough has to be sealed. The individual pins of the strands are protected inside the housing.

The connection points can be plug pins on the distribution element. The main line strands and/or the secondary line strand can be connected to the distribution element by plug-in connections. Alternatively, it is possible that the main line strands and/or the secondary line strand are directly soldered to at least one of the electrical lines on the distribution element. The distribution element may be a hard-wired printed circuit board. Alternatively, the distribution element may be a printed circuit board having a plurality of conductor tracks.

Preferably, the housing of the distributor module is made of plastic. The housing preferably has an access opening that is closed by a cover. The cover can be screwed and/or glued to the housing.

In another preferred embodiment, the distributor module is arranged substantially in close proximity to the roller drive unit. The distributor module may be spaced adjacent to the roller drive unit. In other words, the distributor module may be arranged adjacent to the roller drive unit. A distance of 15 cm to 100 cm (about 5.9 inches to about 39.4 inches) may be provided between the distributor module and the roller drive unit. The distributor module may be spaced a maximum of 40 cm (about 15.7 inches), preferably a maximum of 30 cm (about 11.8 inches), particularly preferably a maximum of 20 cm (about 7.9 inches) from the roller drive unit. Alternatively, it is possible for the distributor module to be spaced a maximum of 15 cm (about 5.9 inches) from the roller drive unit. In this embodiment, it is advantageous that the line length of the secondary line strand is reduced compared to the line lengths known in the prior art, thus reducing material, weight, and an assembly cost.

Preferably, the cargo conveying device has at least one roller arranged between the distributor module and the roller drive unit on the frame. The roller may be roller-shaped. Preferably, the cargo conveying device comprises a plurality of rollers. In this embodiment, the roller between the distributor module and the roller drive unit serves not only for transporting cargo items, but additionally as impact protection for the distributor module as well as the roller drive unit. Particularly preferably, a roller is arranged on both sides of the distributor module in a longitudinal direction of the frame. The roller preferably projects upwards over the housing of the distributor module in the installed position.

In one embodiment, the distributor module has at least one addressing unit for address code assignment to the roller drive unit, which contains an address code of the roller drive unit and/or is configurable with an address code of the roller drive unit. In other words, an addressing unit is provided in which an address code of the roller drive unit is stored and/or which is configurable such that a new address code for the roller drive unit can be assigned to the addressing unit. The address code can be predetermined. Here, it is advantageous that the address information is provided on site by the addressing unit at the roller drive unit. This saves cable lengths and thus costs and weight.

In one embodiment, the addressing unit is programmable. For example, it may have a plurality of magnetic switches, particularly reed switches, and the cargo conveying device may have a plurality of magnets that are magnetically coupleable or coupled to the magnetic switches such that a switching pattern of the magnetic switches results in an address code of the roller drive unit. The number of magnetic switches may correspond to the number of magnets. For example, the switching pattern of the magnetic switches may adjust when the distributor module is mounted to the frame. The switching pattern is comparable to a bit pattern that results in “1” or “0” depending on the switching position of the respective magnetic switch. This results in a pattern that corresponds to the address code of the associated roller drive unit when the switch is in the corresponding position. A controller can thus identify the roller drive unit via the address code when required, i.e. when transporting a piece of cargo, and thus actuate it in a targeted manner. The controller can read out the address code of the roller drive unit, for example, via at least one data bus line, in particular a CAN-BUS line, and control the roller drive unit accordingly.

In one embodiment, the addressing unit comprises at least one, in particular nonvolatile, data memory with stored address code of the roller drive unit. It is possible that the data memory can be written to with an address code and/or the stored address code can be read from the data memory. The data memory has the advantage that the addressing unit is kept simple.

In one embodiment, the addressing unit has at least one RFID tag that can be written with an address code of the roller drive unit. RFID technology is a cost-effective and simple way to store and provide at least one address code of the roller drive unit. The address code of the roller drive unit can be readable from the RFID tag. The encoding of the RFID tag can be carried out via near field communication (“NFC”).

The addressing unit may be arranged integrated in the housing of the distributor module. Preferably, the addressing unit comprises a separate housing arranged in the housing of the distributor module. For example, the magnetic switches for address code generation may be arranged in the separate housing. Additionally or alternatively, a non-volatile data memory and/or at least one RFID tag may be arranged in the separate housing. Alternatively, the addressing unit may be arranged externally on the housing of the distributor module. In this case, a separate housing for the addressing unit may be arranged on the housing of the distributor module. It is possible that at least one, in particular writable and/or readable, RFID tag is adhered to the outside of the housing of the distributor module.

Particularly preferably, the frame has at least one guide channel extending in the longitudinal direction and a cover closing the guide channel, wherein at least one of the main line strands can be arranged or is arranged in the guide channel. This has the advantage that the main line strands for supplying the roller drive unit and/or communication with the roller drive unit are not guided below the cargo hold floor, as is known from the prior art, but extend in the cargo hold floor. These are therefore easily and quickly accessible. Furthermore, the planning, certification and assembly effort is considerably reduced. The guide channel can be formed longitudinally on one of the side walls of the frame.

The guide channel can be groove-like. The guide channel can be opened outward transverse to a center axis of the frame. At the position of the distributor module, the guide channel can be interrupted so that the main line strands can be guided inwards to the distributor module.

In one embodiment, the frame has at least one mounting recess in a first side wall into which the distributor module is inserted by sliding. The mounting recess is formed in the first side wall. The mounting opening may have, at least in sections, as an inner contour, an outer contour of the housing of the distributor module. During assembly, the distributor module can be inserted easily and quickly through the mounting opening transversely to the longitudinal direction of the frame. In the inserted state, the housing of the distributor module is screwed to the first side wall. For this purpose, the housing preferably has a flange region on one end face which, in the inserted state of the housing, rests against the outside of the first side wall.

In a (further) embodiment, the frame has at least one positioning opening in a second side wall and the distributor module has at least one extension, in particular a mandrel, which engages in the positioning opening. The second side wall is arranged opposite the first side wall. The two side walls extend in the longitudinal direction of the frame. The side walls delimit an intermediate space in which the distributor module and the roller drive unit are arranged.

The positioning opening is preferably formed in the second side wall opposite the mounting opening of the first side wall. The positioning opening can be a circular through opening. Alternatively, the positioning opening may have at least one angular inner contour. Preferably, the positioning opening has an inner contour that is complementary to an outer contour of the extension. The extension is preferably formed on a side of the housing opposite the end face. In the inserted state, the extension engages in the positioning opening preferably in a form-fitting manner. In this embodiment, a positioning aid is implemented in that the extension projects into the positioning opening when the distributor module is inserted.

In the installed position, the distributor module is thereby held in the vertical direction, which is perpendicular to the longitudinal direction of the frame. In other words, the distributor module is supported in the frame through the positioning opening.

Preferably, the distribution element has at least one transmitter and/or receiver unit, in particular an RFID unit and/or a Bluetooth unit and/or a radio network unit, for wireless signal transmission. A controller can communicate wirelessly with the distributor module and/or the roller drive unit via the transmitter and/or receiver unit. It is possible that the addressing unit is wirelessly controllable via the transmitter and/or receiver unit, in particular programmable with an address code. This enables wireless communication, for example, of a controller with the distributor module or the roller drive unit.

In one embodiment, the distribution element has at least one sensor, in particular a temperature sensor and/or light sensor and/or vibration sensor and/or magnetism-detecting sensor. In this embodiment, the distributor module is used not only as a branching point for electrical lines to the roller drive unit, but also for detecting ambient parameters. This increases the functional spectrum of the distributor module. Furthermore, the sensors are arranged protected in the housing of the module.

In one embodiment, the cargo conveying system comprises at least one first cargo conveying device and at least one second cargo conveying device, wherein at least one main line strand of the first cargo conveying device is connected to at least one main line strand of the second cargo conveying device using at least one distributor module, in particular for establishing a continuous data bus.

Preferably, a/the distributor module is arranged at at least one longitudinal end of the frame. This allows for simplified connection of the main line strands of the first and second cargo conveying devices.

According to another alternative independent aspect, the invention relates to an aircraft having at least one cargo conveying system according to the invention.

According to another alternative independent aspect, the invention relates to a method of providing a wired cargo conveying system, in particular of an aircraft, comprising the steps of:
attaching partial cable harnesses to frames of cargo conveying devices prior to the insertion of cargo conveying devices into the aircraft and/or prior to assembly;
mounting at least two cargo conveying devices side by side on a cargo deck; and
connecting the partial cable harnesses of the side-by-side mounted cargo conveying devices using a distributor module, wherein the distributor module is attached or attachable to and/or within one of the frames of at least one of the cargo conveying devices.

In a preferred embodiment, the method comprises the following further steps of:
positive and/or frictional connection of the distributor module in and/or to at least one of the frames; and/or
connecting the roller drive unit to the distributor module after the cargo conveying devices have been mounted on the cargo deck, in particular via a plug-in connection; and/or
encoding an address of the roller drive unit using the distributor module.

Regarding the advantages of the aircraft as well as the method, reference is made to the advantages explained in connection with the cargo conveying system. Furthermore, the aircraft and the method may alternatively or additionally have individual or a combination of several features previously mentioned with respect to the cargo conveying system.

### BRIEF DESCRIPTION OF THE DRAWINGS

The invention is explained in more detail below with reference to the accompanying drawings. The embodiments shown represent examples of how the cargo conveying system according to the invention can be designed.

The drawings show as follows:

FIG. 1 shows a perspective view of a cargo conveying system according to a preferred exemplary embodiment of the invention;

FIG. 2 shows a detailed perspective section in the region of a connection point of a distributor module of the cargo conveying system according to FIG. 1;

FIG. 3 shows a reduced exploded view of the cargo conveying system according to FIG. 1;

FIG. 4 shows a partial perspective view of the cargo conveying system according to FIG. 1; and

FIG. 5 shows a perspective view of a cargo conveying system according to a further exemplary embodiment according to the invention, with multiple cargo conveying devices.

In the following description, the same reference numbers are used for identical parts and parts with the same effect.

### DETAILED DESCRIPTION

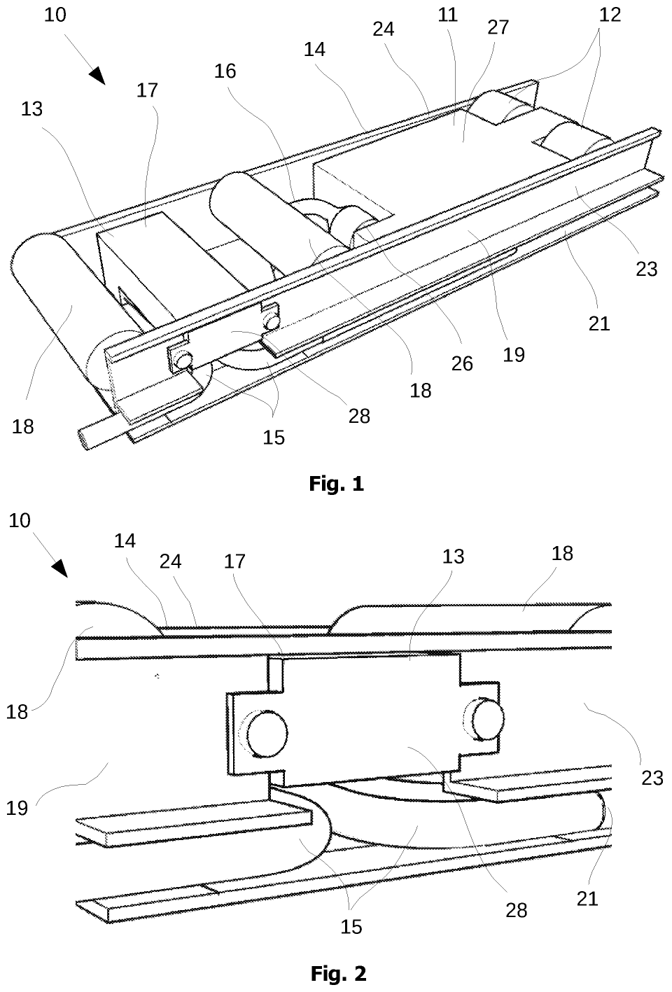

FIGS. 1 to 4 show a cargo conveying system 10 according to an exemplary embodiment of the invention. The cargo conveying system 10 is used for conveying cargo items in a cargo hold of an aircraft. Cargo items can be containers as well as cargo pallets, so-called ULDs “Unit Load Devices”. Other cargo items are possible. A variety of cargo conveying systems 10 may be used in an aircraft to convey cargo items during loading and unloading in the cargo hold.

According to FIG. 5, for example, a cargo conveying system 10 is shown with several cargo conveying devices 14, in particular roller conveyors, arranged in series. In other words, the cargo conveying devices 14 are arranged one after the other in a longitudinal direction.

As shown in FIG. 1, the cargo conveying device 14 of the cargo conveying system 10 has a roller drive unit 11 with two rollers 12. The rollers 12 are drivable. The rollers 12 are used to transport the cargo items. The two rollers 12 are arranged opposite each other at a first longitudinal end of the roller drive unit 11. The roller drive unit 11 has an elongated shape. The roller drive unit 11 comprises an electrical connection 26, in particular a plug socket, for connecting a secondary line strand, which will be discussed in more detail later.

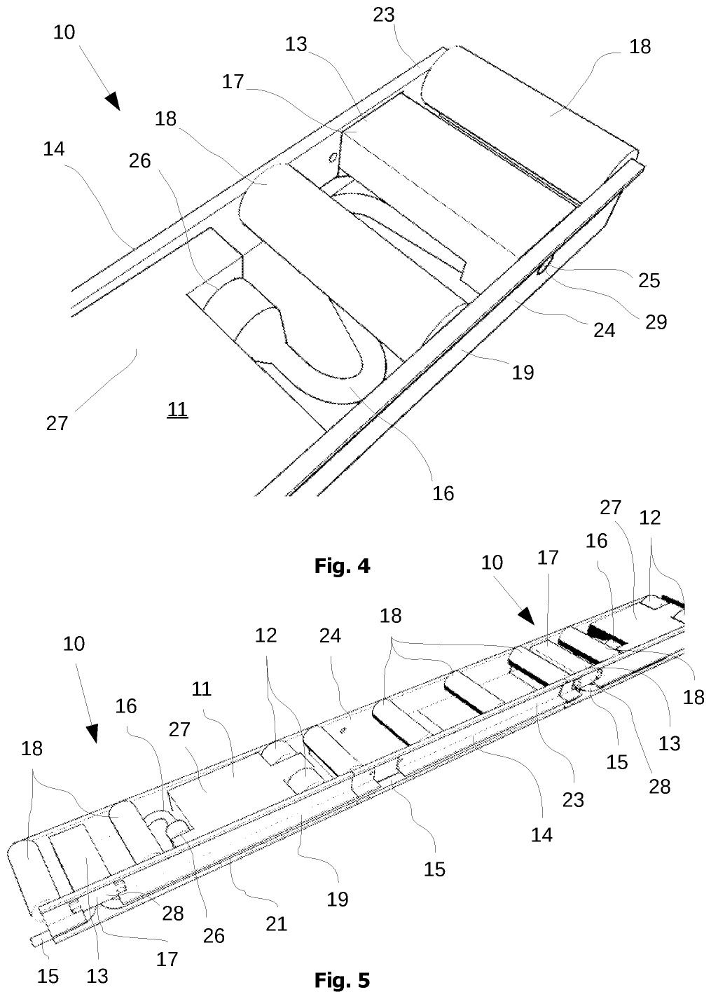

The electrical connection 26 is recessed on the roller drive unit 11. Specifically, the roller drive unit 11 comprises a housing 27 on which a shoulder for the electrical connection 26 is formed. The shoulder is clearly visible in FIG. 4, for example.

Furthermore, the cargo conveying system 10 comprises a distributor module 13 associated with the roller drive unit 11. The distributor module 13 is used to distribute electrical lines for power supply and/or data connection and/or grounding from at least one main line strand 15 toward the roller drive unit 11. Specifically, the distributor module 13 connects a first main line strand 15 to a further main line strand 15. The main line strands 15 are each formed as a partial cable harness. In the following description, the main line strands 15 are generally referred to as partial cable harnesses.

The distributor module 13 has a housing 17 and a distribution element (not shown) integrated into the housing 17. In the exemplary embodiment, the distribution element is a printed circuit board or a circuit board. The distribution element comprises a plurality of connections for electrical lines of the two partial cable harnesses 15. The partial cable harnesses 15 comprise a plurality of electrical lines for the power supply as well as the data connection of the roller drive unit 11. Additionally, grounding lines are provided. The electrical lines are preferably connected to the distribution element via plug pins. A first of the two partial cable harnesses 15 is an input partial cable harness and a second of the two partial cable harnesses 15 is an output partial cable harness. The two partial cable harnesses 15 are connected to each other via the distribution element. The connection may be electrical and/or communicative, i.e. signal transmitting.

The distribution element further comprises further plug pins to which electrical lines of a secondary line strand 16 are connected. Like the partial cable harnesses 15, the secondary line strand 16 comprises electrical lines for the power supply, the data connection and grounding of the roller drive unit 11. The secondary line strand 16 is connected to at least one of the partial cable harnesses 15 via the distribution element. For this purpose, the distribution element can have a fixed wiring and/or conductor tracks.

In general, it is possible for the distribution element to be directly soldered to the electrical leads of the partial cable harnesses 15 and/or the secondary line strand 16.

The secondary line strand 16 has a connector that is connected to the electrical connection 26 of the roller drive unit 11. The secondary line strand 16 extends from the distributor module 13 to the roller drive unit 11 in an S-shape. Other line runs of the secondary line strand 16 are possible.

As can be seen in FIG. 1, the distributor module 13 and the roller drive unit 11 are part of a cargo conveying device 14. The cargo conveying device 14 has a frame 19 on which the distributor module 13 and the roller drive unit 11 are arranged. The frame 19 has a longitudinal extension and is U-shaped. In other words, the frame 19 extends in a longitudinal direction. The frame 19 has two side walls 23, 24 extending in a longitudinal direction and facing each other. The side walls 23, 24 are spaced from each other transversely to the longitudinal direction and define an intermediate space. The distributor module 13 and the roller drive unit 11 are arranged in the intermediate space.

The distributor module 13 and the roller drive unit 11 are spaced from each other in the longitudinal direction of the frame 19. Specifically, the housing 17 of the distributor module 13 is spaced longitudinally from the electrical connection 26 of the roller drive unit 11. The distributor module 13 is disposed in close proximity to the roller drive unit 11 to minimize the line length of the secondary line strand 16. A roller 18 of the cargo conveying device 14 is arranged between the distributor module 13 and the roller drive unit 11. This serves as shock protection for the distributor module 13 and the roller drive unit 11. According to FIG. 1, another roller 18 of the cargo conveying device 14 is arranged upstream of the distributor module 13. The rollers 18 are arranged in the frame 19 so as to be rotatable about their center axis.

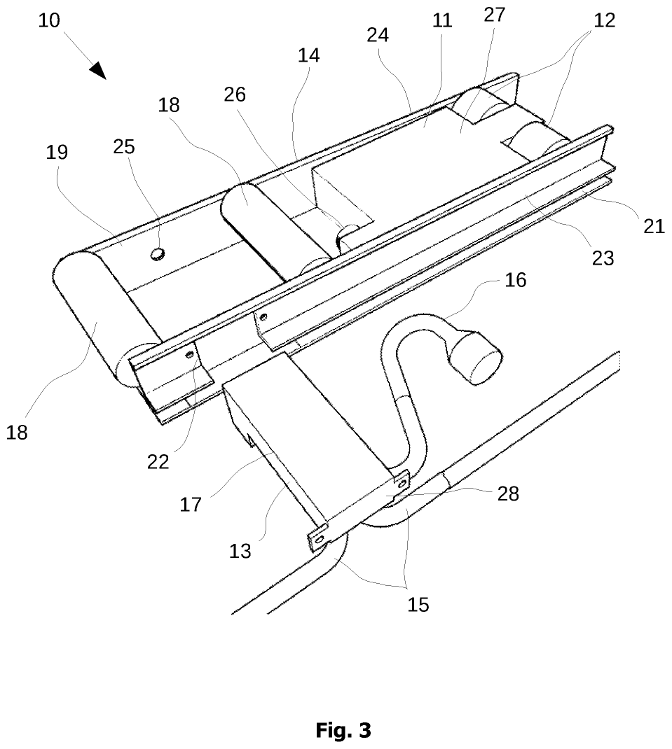

The housing 17 of the distributor module 13 is of L-shaped design. This can be seen in FIGS. 1 and 3. At the shorter of the two legs of the housing 17, sealed passage points of the partial cable harnesses 15 and the secondary line strand 16 are provided. The longer of the two legs of the housing 17 extends transversely to the longitudinal direction of the frame 19. The housing 17 has a flange region 28 at one end face connected to a first of the side walls 23, 24 (see FIG. 2). Specifically, the housing 17 is bolted to the first side wall 23 via the flange region 28. The flange region 28 is plate-shaped and abuts an outer surface of the first side wall 23 transverse to the longitudinal direction. On the side of the housing 17 opposite the end face of the housing 17, a projection 29 is formed which engages in a positioning opening 25 of the second side wall 24. The projection 29 is a cylindrical mandrel. The positioning opening 25 is a circular through-opening.

The first side wall 23 has a mounting recess 22 in which the distributor module 13 with the housing 17 is partially arranged. Specifically, the housing 17 is inserted into the frame 19 through the mounting recess 22.

The frame 19 has a longitudinally extending guide channel 21 on the first side wall 23. The partial cable harnesses 15 are arranged along the frame 19 in the guide channel 21. In the area of the distributor module 13, the guide channel 21 is interrupted, in particular cut free, in order to guide the course of the partial cable harnesses 15 inwards. The partial cable harnesses 15 are arranged recessed along the frame 19. The guide channel 21 can be closed by a cover not shown.

As shown in FIG. 5, the partial cable harnesses 15 extend along the entire frame 19, with one partial cable harness 15 in each case leading to a distributor module 13 and another partial cable harness 15 leading away from the distributor module 13 to the next distributor module 13. The distributor modules 13 are therefore preferably connected to one another in series. This likewise applies to the partial cable harnesses 15. It is further apparent from FIG. 5 that the cargo conveying device 14 comprises a plurality of rollers 18. The cargo conveying system 10 according to FIG. 5 is a roller conveyor comprising a plurality of cargo conveying devices 14 arranged in succession. The partial cable harnesses 15 of the successively arranged cargo conveying devices 14 are interconnected by the distributor modules 13.

A method of providing a wired cargo conveying system 10 as shown in FIG. 5 is described below.

In a first step, the partial cable harnesses 15 are attached to the frames 19, in particular frame pieces, of the cargo conveying devices 14 before the cargo conveying devices 14 are brought into the cargo hold of an aircraft and before the cargo conveying devices 14 are mounted. In this process, the partial cable harnesses 15 are inserted into the guide channels 21 of the frames 19 and are preferably held in position by a cover. The cargo conveying devices 14 are then mounted one after the other. These are firmly connected to one another in the longitudinal direction. The cargo conveying devices 14 lined up one after the other form a roller conveyor. In a further subsequent step, the partial cable harnesses 15 of two cargo conveying devices 14 arranged next to each other are connected using one of the distributor modules 13, wherein the distributor module 13 is arranged in the frame 19 and fastened to the latter.

The distributor module 13 shown in FIGS. 1 to 5 further comprises an addressing unit, not shown, for assigning addresses to the associated roller drive unit 11. The addressing unit contains a predetermined address code of the roller drive unit 11 and/or is configurable with an address code of the roller drive unit 11. Preferably, the addressing unit is arranged integrated in the housing 17 of the distributor module 13. Alternatively, the addressing unit may be arranged externally on the housing 17 of the distributor module 13.

The addressing unit may have a plurality of magnetic switches, in particular reed switches, and the cargo conveying device 14 may have a plurality of magnets that are magnetically couplable or coupled to the magnetic switches such that a switching pattern of the magnetic switches results in an address code of the roller drive unit 11. The number of magnetic switches corresponds to the number of magnets.

For example, the switching pattern of the magnetic switches is set when the distributor module 13 is mounted on the frame 19. The switching pattern is comparable to a bit pattern that results in “1” or “0” depending on the switch position of the respective magnetic switch. This results in a pattern corresponding to the address code of the associated roller drive unit 11 when the switch is in the corresponding position. A controller can thus identify the roller drive unit 11 by means of the address code when required, i.e. when transporting a cargo item, and thus actuate it in a targeted manner. The controller can read out the address code of the roller drive unit 11, for example, via a data bus line, in particular a CAN-BUS line, and control the roller drive unit 11 accordingly.

The addressing unit may additionally or alternatively comprise at least one nonvolatile data memory with stored address code of the roller drive unit 11. The data memory can be connected to a controller in a signal-transmitting manner. The addressing unit may additionally or alternatively comprise at least one RFID tag that is writable with an address code of the roller drive unit 11 and/or from which an address code of the roller drive unit 11 is readable.

The distributor module 13 may additionally comprise at least one transmitter and/or receiver unit, in particular an RFID unit and/or a Bluetooth unit and/or a radio network unit, for wireless signal transmission with a controller. Preferably, the distribution element comprises at least one sensor, in particular temperature sensor and/or light sensor and/or vibration sensor and/or magnetism-detecting sensor. In this case, the sensor is integrated into the housing 17.

At this point, it should be noted that, particularly with reference to the details shown in the drawings, features described in the context of separate embodiments can also be implemented in combination in a single embodiment. Conversely, various features that are described in the context of a single embodiment can also be implemented in multiple embodiments separately or in any suitable subcombination.

### LIST OF REFERENCE SIGNS

10 Cargo conveying system
11 Roller drive unit
12 Roller of the roller drive unit
13 Distributor module
14 Cargo conveying device
15 Main line strands
16 Secondary line strand
17 Housing
18 Roller of the cargo conveying device
19 Frame
21 Guide channel
22 Mounting recess
23 First side wall
24 Second side wall
25 Positioning opening
26 Electrical connection of the roller drive unit
27 Housing of the roller drive unit
28 Flange area
29 Projection

1. A cargo conveying system for conveying items of cargo in a cargo hold of an aircraft having at least one cargo conveying device, wherein the cargo conveying device comprises:
at least one frame;
at least one roller drive unit having at least one roller for conveying the cargo items;
at least one main line strand arranged on the frame; and
at least one distributor module for connecting the at least one main line strand to at least one further main line strand, wherein the distributor module is arranged on and/or in the frame and is connected to the roller drive unit via at least one secondary line strand.

2. The cargo conveying system according to claim 1, wherein the distributor module has a housing, and at least one distribution element integrated in the housing and having a plurality of connection points to which the main line strands and/or the secondary line strand are connected.

3. The cargo conveying system according to claim 1, wherein the distributor module is arranged substantially in close proximity to the roller drive unit.

4. The cargo conveying system according to claim 1, wherein the distributor module has at least one addressing unit for address code assignment to the roller drive unit, which contains a predetermined address code of the roller drive unit and/or can be configured with an address code of the roller drive unit.

5. The cargo conveying system according to claim 4, wherein the addressing unit has a plurality of magnetic switches, and the cargo conveying device has a plurality of magnets which can be magnetically coupled or are coupled to the magnetic switches in such a way that a switching pattern of the magnetic switches results in an address code of the roller drive unit.

6. The cargo conveying system according to claim 4, wherein the addressing unit comprises at least one data memory with stored address code of the roller drive unit and/or the addressing unit has at least one RFID tag which can be written with an address code of the roller drive unit and/or from which an address code of the roller drive unit can be read.

7. The cargo conveying system according to claim 4, wherein the addressing unit is arranged integrated in the housing of the distributor module or the addressing unit is arranged externally on the housing of the distributor module.

8. The cargo conveying system according to claim 1, wherein the frame comprises at least one longitudinally extending guide channel and a cover closing the guide channel, wherein at least one of the main line strands is arrangeable or arranged in the guide channel.

9. The cargo conveying system according to claim 1, wherein the frame has at least one mounting recess in a first side wall, into which the distributor module is inserted by sliding.

10. The cargo conveying system according to claim 9, wherein the frame comprises at least one positioning opening in a second side wall and the distributor module comprises at least one projection which engages in the positioning opening.

11. The cargo conveying system according to claim 1, wherein the distribution element comprises at least one transmitter and/or receiver unit for wireless signal transmission and/or the distribution element comprises at least one of a temperature sensor and/or light sensor and/or vibration sensor and/or magnetism-detecting sensor.

12. The cargo conveying system according to claim 1, comprising at least one first cargo conveying device and at least one second cargo conveying device, wherein at least one main line strand of the first cargo conveying device is connected to at least one main line strand of the second cargo conveying device using at least one distributor module for establishing a continuous data bus.

13. An aircraft having at least one cargo conveying system according to claim 1.

14. A method of providing a wired cargo conveying system in an aircraft, the method comprising the steps of:
attaching partial cable harnesses to frames of cargo conveying devices prior to insertion of the cargo conveying devices into the aircraft and/or prior to assembly;
mounting at least two cargo conveying device side by side on a cargo deck; and
connecting the partial cable harnesses of the side-by-side mounted cargo conveying device using a distributor module, wherein the distributor module is attached or attachable to and/or within one of the frames of at least one of the cargo conveyors.

15. The method according to claim 14, wherein
the distributor module is positively and/or non-positively fastened in and/or to at least one of the frames; and/or
a roller drive unit is connected to the distributor module after the cargo conveying device have been mounted on the cargo deck; and/or
an address of the associated roller drive unit is encoded using the distributor module.
